(19) United States
(12) Patent Application Publication
(10) Pub. No.: US 2023/0335705 A1
(43) Pub. Date: Oct. 19, 2023

(54) METHODS AND SYSTEMS FOR CATHODE WITH HIGH STRUCTURAL LITHIUM CONTENT

(71) Applicant: A123 Systems LLC, Waltham, MA (US)

(72) Inventors: Lei Liu, Cambridge, MA (US); Bryan Kim, Billerica, MA (US); Bitna Choi, Duluth, GA (US); Eunsung Lee, Novi, MI (US); Anil Parmar, Marlboro, MA (US); Kitae Kim, Glenview, IL (US); Yang Chen, Burlington, MA (US)

(21) Appl. No.: 18/301,081

(22) Filed: Apr. 14, 2023

Related U.S. Application Data
(60) Provisional application No. 63/363,094, filed on Apr. 15, 2022.

(51) Int. Cl. H01M 4/04; H01M 4/1391; H01M 4/525; H01M 4/505; C01G 53/00

(52) U.S. Cl. CPC H01M 4/0471; H01M 4/1391; H01M 4/525; H01M 4/505; C01G 53/50; C01P 2002/50; C01P 2006/40; C01P 2004/84

(57) ABSTRACT

Systems and methods for fabricating an electrode are disclosed. In one example, a fabrication process for the electrode includes increasing an electrochemical performance of a battery by adjusting a distribution of lithium in the electrode between a surface and interstitial sites of the electrode. The fabrication process includes mixing, calcinating, rinsing, and sintering electrode materials and the fabrication process is optimized to increase lithium in the interstitial sites and decrease lithium at the surface of the electrode.

### CROSS REFERENCE TO RELATED APPLICATIONS

The present application claims priority to U.S. Provisional Application No. 63/363,094, entitled “METHODS AND SYSTEMS FOR CATHODE WITH HIGH STRUCTURAL LITHIUM CONTENT”, and filed on Apr. 15, 2022. The entire contents of the above-listed application are hereby incorporated by reference for all purposes.

### FIELD

The present description relates generally to a cathode for a lithium-ion battery cell.

### BACKGROUND AND SUMMARY

Lithium-ion (Li-ion) battery cells present a lightweight, compact, high performing alternative to conventional battery cells, such as those used in lead-acid batteries. The high performance of Li-ion battery cells includes desirable attributes such as increased charge cycles, high energy density, low self-discharge rate, as well as incorporation of less heavy metals compared to, for example, nickel-cadmium and nickel-metal hydride battery cells. As such, use of Li-ion battery cell in electric and hybrid-electric vehicles is increasingly desirable. In particular, for fully electric vehicles, Li-ion battery cells offer longer duration between recharging events. However, as the energy density of Li-ion battery cells remains lower than that of gasoline, strategies to enhance their performance is desirable.

For example, battery cell energy density and cycling capacity may be affected by a composition and elemental distribution of a Li-ion battery cell cathode. However, controlling the composition and elemental distribution to increase an electrochemical performance of the cathode via techniques that remain robust across various manufacturing protocols may be challenging. More specifically, a partitioning of Li between surfaces of the cathode, e.g., surface Li, and incorporation into a crystal structure lattice of the cathode material, e.g., structural Li, may be variable and inconsistent. As the structural Li provides electrochemical charge transfer, its compositional content in the cathode directly affects battery performance. By increasing structural Li in the cathode, an energy density and cycling capacity of the cathode may be increased. In contrast, a presence of surface Li may obstruct Li ion diffusion paths and may also cause gas generation in the Li-ion battery cells. Decreasing the surface Li while increasing the structural Li in the cathode may therefore enhance battery performance overall.

The inventors have identified the above problems and have determined solutions to at least partially solve them. In one example, a method for fabricating an electrode, includes increasing an electrochemical performance of a battery by adjusting a distribution of lithium in the electrode between a surface and interstitial sites of the electrode during a fabrication process, the fabrication process including mixing, calcinating, rinsing, and sintering electrode materials. The fabrication process may be optimized to increase lithium in the interstitial sites and decrease lithium at the surface of the electrode. In this way, an electrochemical performance of the battery, such as charge and cycling capacity, may be increased without incorporation of additional materials.

As an example, an optimal total Li distribution between the surface and interstitial sites of the electrode may be determined, which may include increasing the content of Li within the interstitial sites relative to Li at the surface of the electrode. In order to fabricate an electrode demonstrating the optimal Li distribution, parameters of each step of the fabrication process may be adjusted to control the total Li distribution of the resulting electrode. As a result, an energy density and useful life of the battery may be increased via low cost strategies.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an electrode for a Li-ion battery cell.

FIG. 2 shows an example of a manufacturing process for the electrode of FIG. 1.

FIG. 3 shows a graph depicting an effect of a Li to transition metal (TM) mixing ratio on a surface Li content of electrode samples.

FIG. 4 shows a graph depicting a distribution of total Li according to the Li to TM mixing ratio in the electrode samples of FIG. 3.

FIG. 5 shows an example of a calcination temperature profile used during the manufacturing process of FIG. 2.

FIG. 6 shows a graph depicting an effect of temperature on a surface Li content of electrode samples during a pre-sintering phase of the calcination temperature profile of FIG. 5.

FIG. 7 shows a graph depicting an effect of temperature during the pre-sintering phase on total Li distribution of the electrode samples of FIG. 6.

FIG. 8 shows a graph depicting an effect of calcination atmosphere on total Li distribution of electrode samples.

FIG. 9 shows a graph depicting solubilities of surface Li species in a solution used during a rinsing step of the manufacturing process of FIG. 2.

FIG. 10 shows a graph depicting an effect of an amount of rinse solution used during the rinsing step on surface Li content of electrode samples.

FIG. 11 shows a graph depicting an effect of the amount of rinse solution used during the rinsing step on total Li distribution of the electrode samples of FIG. 10.

FIG. 12 shows a graph depicting an effect of temperature on total Li distribution of electrode samples during a second sintering step of the manufacturing process of FIG. 2.

FIG. 13 shows a graph depicting an effect of surface doping on total Li distribution of electrode samples.

FIG. 14 shows a map of optimal ranges of structural and surface Li content in an electrode.

FIG. 15 shows a graph depicting total Li distributions of a set of electrode samples used for analysis and testing.

FIG. 16 shows a graph depicting initial charge capacities of the set of electrode samples of FIG. 15.

FIG. 17 shows a graph depicting a specific capacity relative to cycle number for each of the set of electrode samples of FIG. 15.

FIG. 18 shows a graph depicting a retention capacity relative to cycle number for each of the set of electrode samples of FIG. 15.

### DETAILED DESCRIPTION

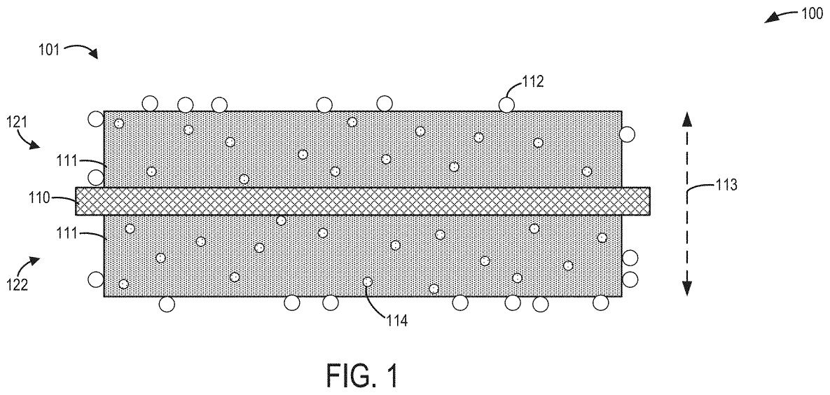

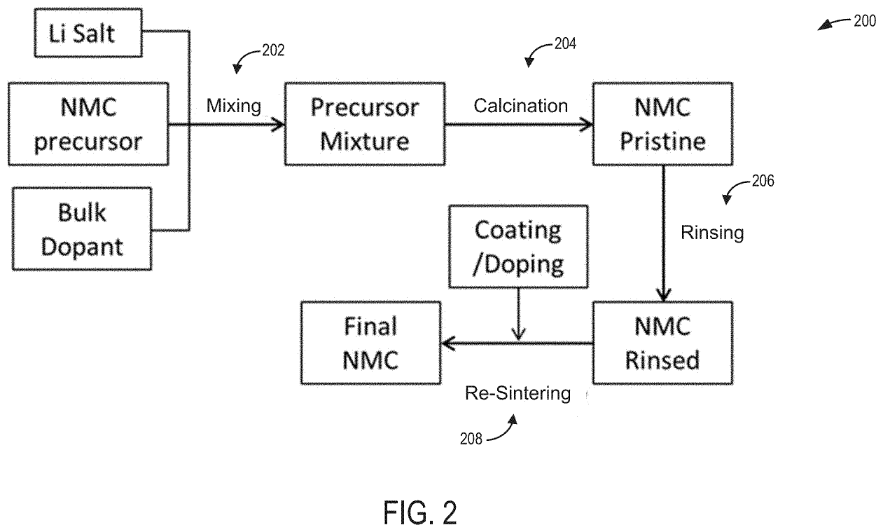

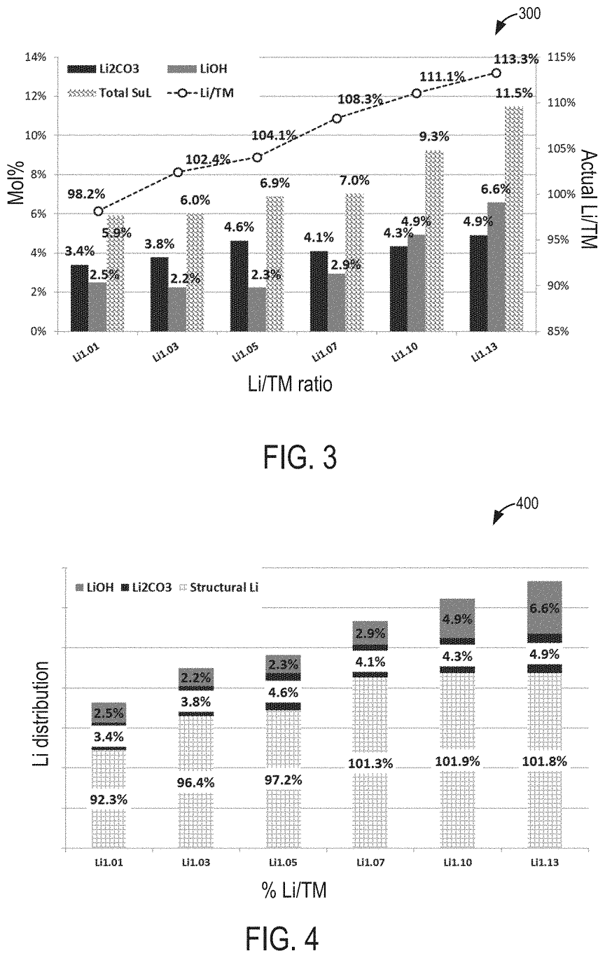

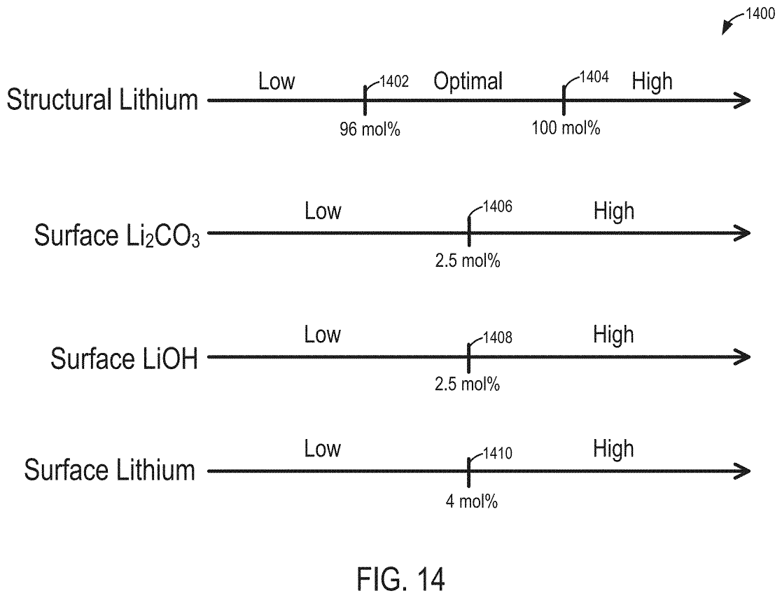

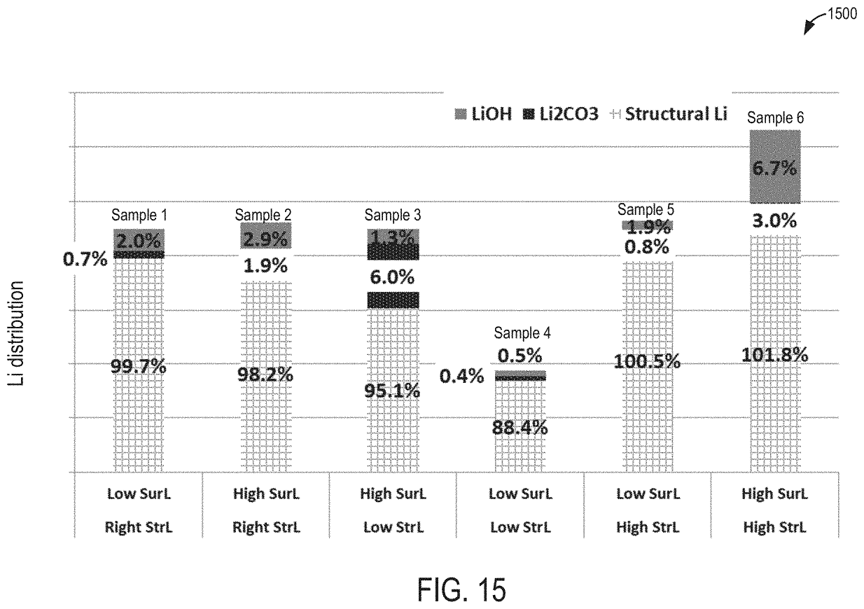

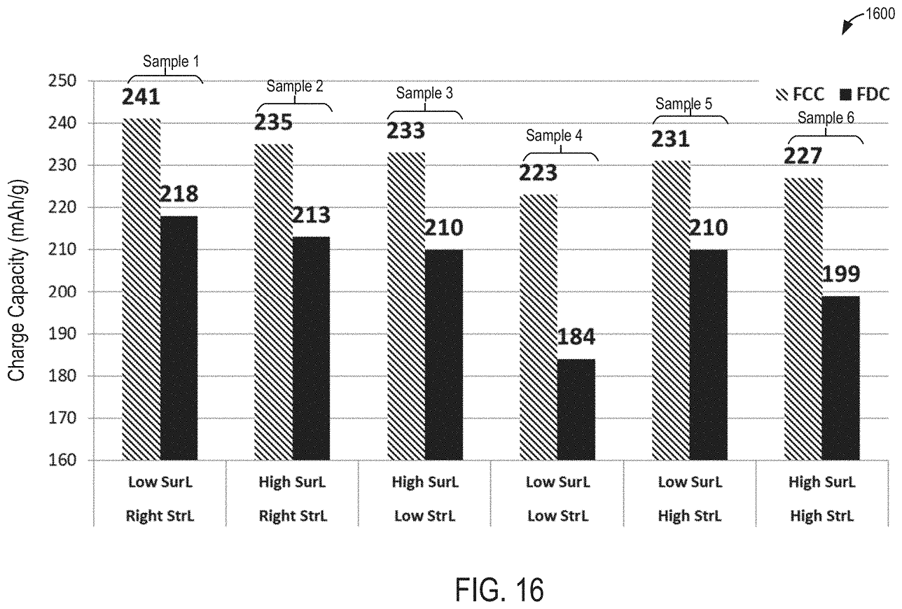

The following description relates to systems and methods for an electrode for a lithium-ion battery cell. The electrode may be a lithium nickel cobalt manganese oxide cathode, in one example, as illustrated in a schematic diagram in FIG. 1. The cathode may be fabricated via a manufacturing process depicted in FIG. 2, including a series of steps. Effects of varying processing parameters on Li distribution of electrode samples are shown in FIGS. 3-13. Target ranges for each of structural Li and surface Li, as determined based on electrochemical testing, are mapped in FIG. 14. Total Li distributions of a set of samples for electrochemical testing are shown in FIG. 15 and results of the electrochemical testing are depicted in FIGS. 16-18.

Referring now to FIG. 1, a schematic diagram 100 illustrating an electrode 101 for use in a battery cell is shown. In one example, as described herein, the electrode 101 may be a positive electrode (cathode). Upon formation, the electrode 101 may be positioned in the battery cell, for example, in a lithium-ion battery cell, such that the electrode 101 may provide power to the battery cell. In some examples, the battery cell may be one of a plurality of battery cells in a battery pack, where each of the plurality of battery cells may have substantially similar configurations (“substantially” may be used herein as a qualifier meaning “effectively”). It will be appreciated that the embodiment depicted FIG. 1 is a non-limiting example, and other electrode configurations are possible without departing from the scope of the present disclosure. For example, the electrode 101 may be multi-layered coated electrode including two or more layers formed of similar or different materials.

The electrode 101 may include a current collector 110 having a first side 121 and a second side 122, where the sides 121, 122 are opposite to one another. The current collector 110 may have a coating layer 111 disposed on one or both of the sides 121, 122, such that the first coating layer 111 may be in face-sharing contact with the current collector 110. As such, in some examples, the electrode 101 may sequentially include the coating layer 111, the current collector 110, and the coating layer 111 along an axis 113 parallel to a smallest dimension of the current collector 110.

The current collector 110 may be a metal sheet or foil, such as copper foil, nickel foil, aluminum foil, etc., or any other configuration which may conduct electricity and permit current flow therethrough. In some examples, the current collector 110 may further include a carbon coating on the metal sheet or foil (e.g., the current collector 110 may be a carbon-coated aluminum foil or a carbon-coated copper foil). In one example, the carbon coating may include no binder (e.g., the carbon coating may be bound to the metal sheet or foil via an alternate method, such as via chemical vapor deposition). However, when a binder is incorporated, the binder may include one or more of polystyrene-butadiene rubber (SBR), carboxymethyl cellulose (CMC), an acrylate polymer, an acrylate-SBR copolymer, an acrylate-coated SBR, and polyvinylidene fluoride (PVDF). In additional or alternative examples, the binder may include one or more of polyvinyl alcohol (PVA), starch, hydroxypropylcellulose, regenerated cellulose, polyvinylpyrrolidone (PVP), tetrafluoroethylene, polyethylene, polypropylene, ethylene propylene diene monomer rubber (EPDM), sulfonated EPDM, and a fluorine rubber.

In other examples, the current collector 110 may include no carbon coating (e.g., the current collector 110 may be a pristine metal sheet or foil). When the electrode 101 is a cathode, the current collector 110 may be aluminum foil. It will be appreciated that the current collector 110 may be varied in thickness, for example, up to 500 within the scope of the present disclosure. In one example, the thickness of the current collector 110 may be about 10 μm. As used herein, “about” or “approximately” when referring to a quantitative property or numerical value may encompass a deviation of 5% or less.

As a cathode, the coating layer 111 of the electrode 101 may include an active material, e.g., electrochemically active, that enables charge transfer by reversibly intercalating and de-intercalating lithium ions. For example, the active material may include one or more of lithium nickel cobalt manganese oxide (NMC), a lithium iron phosphate (LFP), a lithium nickel cobalt aluminum oxide (NCA), a lithium cobalt oxide (NCO), a lithium manganese nickel oxide (LMN), a lithium manganese oxide (LMO), a lithium cobalt phosphate (LCP), a lithium nickel phosphate (LNP), and a lithium manganese phosphate (LMP). It will be appreciated that lithium nickel cobalt manganese oxide may also be abbreviated as NCM, in some examples.

In one example, as described herein, at least one active material of the cathode is NMC which may have a general formula of LiₐNiₓCo_{y}Mn_{1-x-y}O₂. In additional or alternative examples, the general formula may be lithium-rich, so that a>1, or stoichiometric, so that a=1. Furthermore, in some examples, the formula may include values for x of 0.83 or 0.87. However, other values <1 have been contemplated. In an embodiment described herein, a ratio of Li:transition metals:oxide, where the transition metals include nickel, cobalt and manganese, may be 1:1:1.

Lithium (Li) may be present in the cathode as surface Li and structural Li. Surface Li, also referred to as residual Li, may form a predominant portion of a soluble base content of the cathode and may include lithium carbonate (Li₂CO₃) and lithium hydroxide (LiOH). An outer surface of the cathode may be at least partially covered with surface Li. For example, as shown in FIG. 1, surface Li particles 112 may be present along outer surfaces of the coating layer 111 of the electrode 101. Structural Li, however, may be incorporated into a crystal structure of the NMC such that Li atoms are included in the crystal lattice, as depicted in FIG. 1 by structural Li particles 114 embedded within the coating layer 111 of the electrode 101. The structural Li particles 114 may be intercalated into interstitial sites of the crystal structure, for example.

Surface Li and structural Li may each affect an electrochemical performance of the Li-ion battery cell, albeit in different manners. Surface Li, formed of Li salts that are electrochemically inactive in the battery cell, may block Li ion diffusion paths and promote gas generation, thereby decreasing a charge capacity of the Li-ion battery cell. In contrast, structural Li may enhance battery cell performance when present within a target range (e.g., a target mol %) within the NMC, by providing Li ions for charge transfer. A total amount of Li within the cathode may be defined as a sum of surface Li and structural Li, as shown in Equation 1.

Structural Li=Total Li−Surface Li (1)

A distribution of the total Li between surface and structural Li may be optimized to increase battery cell performance. Additionally, battery cell performance may also depend on a Li (e.g., total Li) to transition metal (TM) ratio of the cathode, where the transition metals include Ni, Mn, and Co.

Controlling the distribution of Li and the Li/TM ratio in the cathode is challenging due to steps included in a manufacturing process for forming the cathode. Each step of the manufacturing process may alter these parameters by affecting chemical reactions that the electrode materials are subjected to or undergo. Thus, monitoring an effect of each step and evaluating resulting Li distribution and Li/TM ratio may enable the final cathode material composition to be regulated and optimized.

An example of a manufacturing process 200 for a NMC cathode, such as the electrode 101 of FIG. 1, is illustrated in a flow diagram in FIG. 2. Each step in the manufacturing process 200 is denoted by arrows and materials included in each step are represented by boxes. For example, at a first step 202, a Li salt, a NMC precursor, and a bulk dopant are mixed. A relative amount of the Li salt to the NMC precursor may be selected to provide a Li-rich Li/TM ratio. For example, a target Li/TM ratio may be between 1.00 to 1.10. By selecting the Li-rich Li/TM ratio, excess Li salt may compensate for loss of Li during subsequent steps in the manufacturing process 200 and suppress Li/Ni disorder. Any remaining excess Li salt may form surface Li on the NMC surface which may be reduced during a later rinsing step. In one example, the Li salt may be LiOH. As another example, the Li salt may be Li₂CO₃.

The NMC precursor may include nickel hydroxide and/or nickel oxide, cobalt hydroxide and/or cobalt oxide, and manganese hydroxide and/or manganese oxide. The bulk dopant may include one or more dopants such as an oxide, or another type of salt, formed of one of more elements such as Al, Mg, Mn, Co, Ni, Ti, Zr, Sn, Cu, Ca, Ba, Ce, Y, Nd, W, Ba, Na, K, F, Cl, Br, I, S, Se, P, Sb, Bi, Si, Ge, Sn, Pb, Ga, In, Ag, etc. The dopants may increase a physical and thermal stability of a crystal structure of the NMC and may be readily diffused into a particle of the NMC.

An effect of the Li/TM mixing ratio on surface Li content of the cathode is illustrated in FIGS. 3-4. Turning first to graph 300 of FIG. 3, a percent content of total surface Li, and distribution of the total surface Li between Li₂CO₃ and LiOH, is shown for six cathode samples, relative to a first y-axis indicating mol % positioned on a left-hand side of graph 300. The surface Li contents are depicted relative to a theoretical mixing Li/TM ratio of each sample, as shown along the x-axis, where the mixing Li/TM ratio is a ratio of the amounts of the Li salt and NMC precursor used in the first step 202 of FIG. 2. An actual Li/TM ratio of the fabricated cathode as a percentage is also plotted in graph 300 relative to a second y-axis positioned on a right-hand side of the graph 300, the actual Li/TM ratio denoted by dashed lines connecting open circles. The Li/TM mixing ratio may be configured for synthesis of NMC Ni87.

A distribution of a total Li content between structural Li, Li₂CO₃, and LiOH for each of the samples of graph 300 is shown in graph 400 of FIG. 4. The percent Li/TM ratio is indicated along the ordinate and the percent distribution of Li is indicated in each portion of each column. As shown in graphs 300 and 400, the surface Li and structural Li content both generally increase as the Li/TM ratio increases. However, as shown in graph 400, at Li/TM ratios greater than 1.07, surface Li continues to increase while structural Li becomes relatively uniform. Thus, for the Ni content of these samples, a Li/TM ratio of 1.07 may define a boundary above which intercalation of additional Li ceases. This boundary or threshold may vary according to the specific Ni content of the NMC and determination of the threshold for each sample may enable formation of a cathode with a highest proportion of structural Li while inhibiting undesirable surface Li growth. As transformation of surface Li back to structural Li is minimal during the manufacturing process 200, determining a correct initial structural Li content may set an upper threshold of the final NMC.

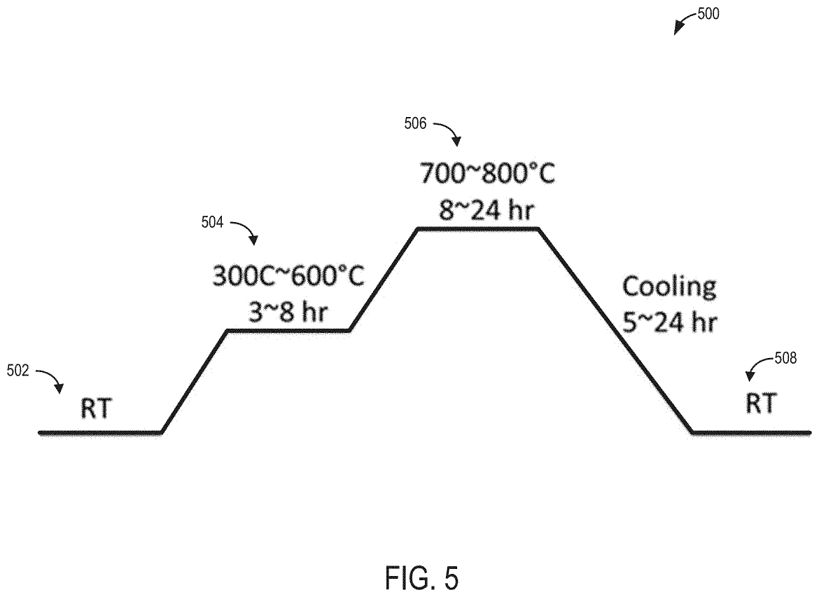

Returning to FIG. 2, at a second step 204 of the manufacturing process 200 the precursor mixture is calcinated. Of the various phases of the calcination process, as shown in FIG. 5, a temperature during a pre-sinter plateau and a calcination atmosphere have a greatest impact on the structural Li content. Calcination of the precursor mixture includes heating the mixture under pure oxygen to remove impurities and volatile species. The precursor mixture may also be sintered, which may occur at a lower temperature range than a calcination temperature range, during the second step 204 as the temperature rises. A calcination temperature profile applied during the second step 204 may affect an amount of Li that diffuses into the NMC precursor to form structural Li. An example of a calcination temperature profile 500 is shown in FIG. 5.

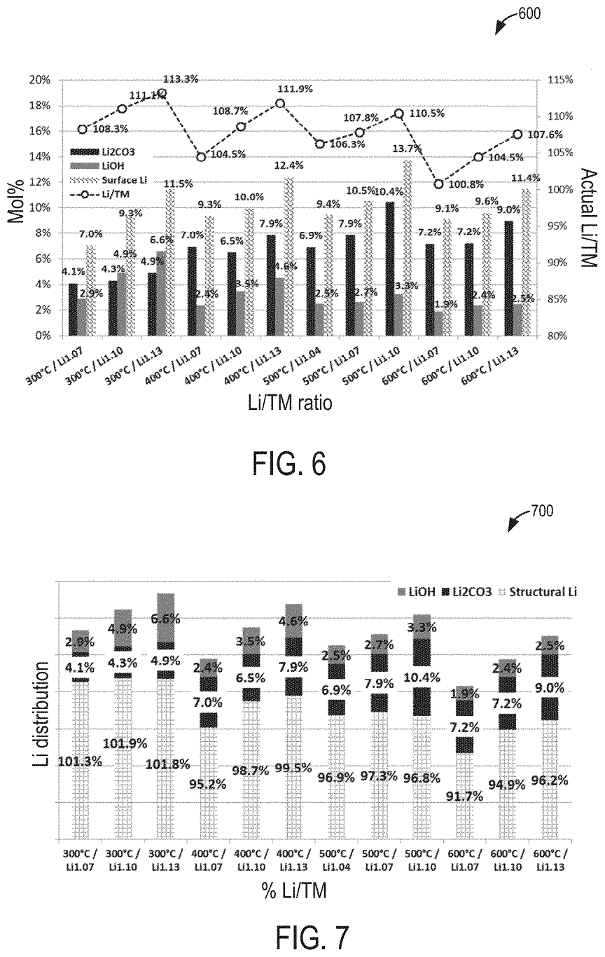

The calcination temperature profile 500 includes a first plateau 502 at room temperature. The temperature is ramped up to reach a second plateau 504, which may be a pre-sintering phase, where the temperature is held at a temperature between 300° C. and 600° C. for 3 to 8 hours. During the pre-sintering phase, the Li salt melts and percolates into the NMC precursor. The temperature selected for pre-sintering may regulate the distribution of total Li between surface Li and structural Li in the fabricated cathode. An effect of the pre-sintering temperature is shown in FIGS. 6 and 7, which are plotted similarly as graphs 300 and 400, respectively, e.g., graph 600 of FIG. 6 is plotted relative to the same y-axes as graph 300, and similarly depicting surface Li content and distribution as well as the actual Li/TM ratio, and graph 700 of FIG. 7 is plotted relative to the same parameters as graph 400. Only three of the samples of graphs 300 and 400 (samples with the Li/TM mixing ratio of 1.07, 1.10, and 1.13) are shown in graphs 600 and 700 and each of the samples is pre-sintered at 300° C., 400° C., 500° C., and 600° C., as shown along the x-axes of graphs 600 and 700. For the samples shown in graphs 600 and 700, the Li salt used for mixing is LiOH.

As shown in graph 600, as pre-sintering temperature increases from 300° C. to 500° C., surface Li increases. At 600° C., the surface Li content is similar to the surface Li content at 300° C. The structural Li content, however, is lowest for all samples at 600° C. and highest at 300° C., as shown in graph 700. As a reaction between the LiOH and the NMC precursor is initiated at ˜400° C., the results depicted in graphs 600 and 700 indicate that using a temperature at a low end of a pre-sintering temperature range of the Li salt may enhance diffusion of the Li salt into the TM matrix.

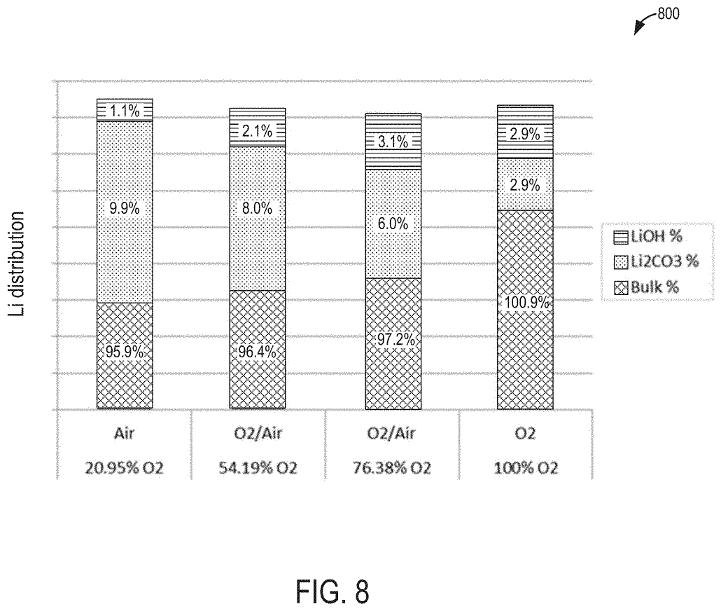

Returning to FIG. 5, the temperature is further increased to a third plateau 506 between 700° C. and 800° C. for 5 to 24 hours, which may be a calcination phase. Following the calcination phase, the sample is cooled over 5 to 24 hours to room temperature at a fourth plateau 508 of the calcination temperature profile 500. While the calcination temperature profile 500 may affect structural Li content by modulating how much of the Li salt is able to melt and infiltrate available sites in the NMC precursor, the calcination atmosphere may also have an effect on total Li distribution by suppressing side reactions of the Li cation and enabling a high valence state of Ni in high Ni NMC to be obtained. For example, if calcination is conducted in air, the Li cation of the Li salt may react with carbon dioxide or water during the cooling period between the third plateau 506 and the fourth plateau 508 of the calcination temperature profile 500 of FIG. 5 to form surface Li (e.g., Li₂CO₃ and LiOH). By performing the calcination step under a pure oxygen environment, formation of surface Li is at least partially suppressed, as illustrated in graph 800 of FIG. 8.

Graph 800 shows a total Li distribution between Li₂CO₃, LiOH, and structural Li according to the calcination atmosphere (e.g., as plotted along the x-axis). The percent Li/TM mixing ratio is indicated in each portion of each column. The structural Li content is highest for the sample exposed to pure oxygen which also shows the lowest Li₂CO₃. While the LiOH content is similar to that of the samples calcinated under an air/oxygen mixture and higher than the sample calcinated under air, the decrease in Li₂CO₃ content in the pure oxygen sample relative to the other samples is greater in magnitude than variations in the LiOH content amongst the samples. Thus, calcination under pure oxygen may suppress at least the formation of Li₂CO₃.

A closed furnace system supplied with oxygen used to generate the results shown in graph 800 may drive formation of higher structural Li content and lower surface Li content when all other conditions are equivalent. The formation of surface Li may lower the structural Li content as the total Li remains similar even in different atmospheres. The closed furnace system, however, results in a structural Li content of 100.9 mol %, which is not theoretically possible and may result from underestimation of the surface Li arising from a small amount of residual surface Li on the NMC surface.

The calcination temperature profile 500 of FIG. 5 is provided as a non-limiting example of a calcination temperature profile which may be used during manufacturing of a cathode. Other examples may include variations in sintering temperature, sintering duration, temperature ramping rate, temperature cooling rate, sintering atmosphere composition, gas flow rate, direction, pattern, etc.

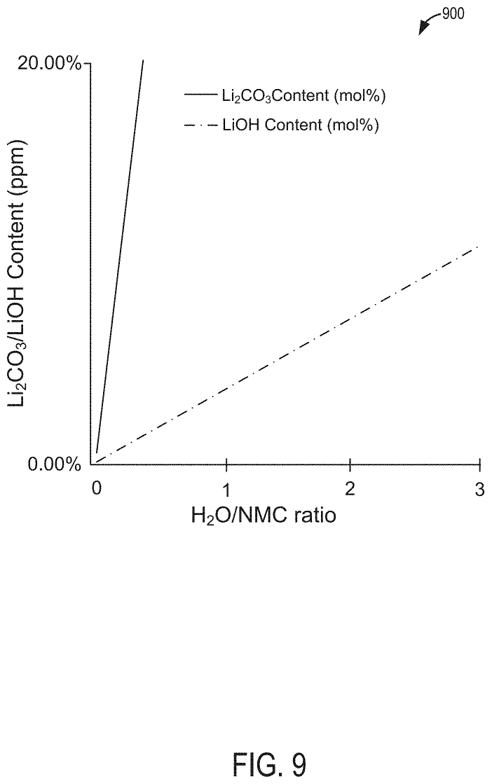

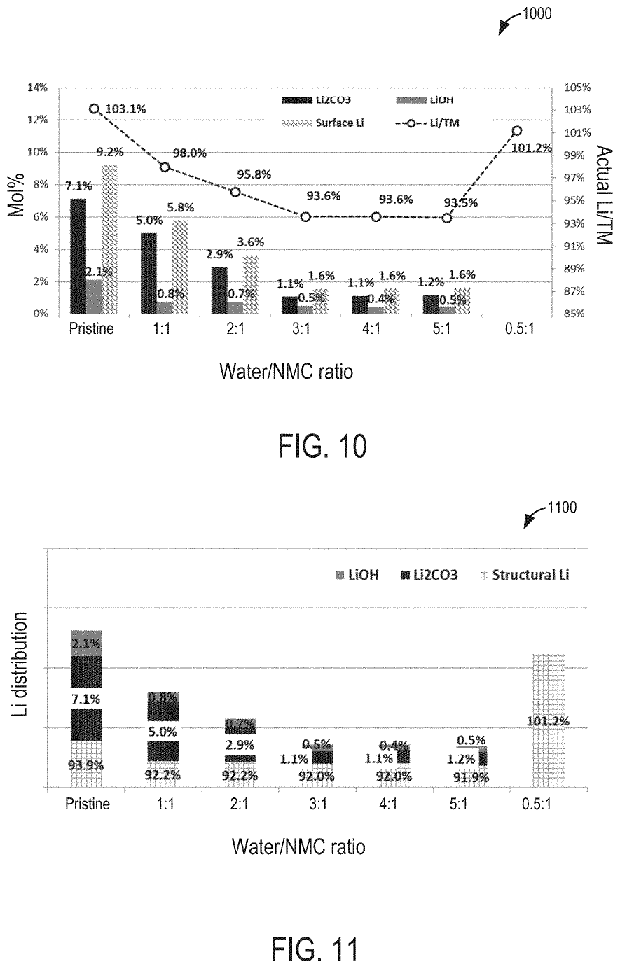

Returning to FIG. 2, a third step 206 of the manufacturing process 200 includes rinsing the pristine Li-infiltrated NMC. Rinsing the NMC may be an effective process for removing surface lithium. In one example, the rinse solution may be water and an amount of water used to rinse the NMC may be determined based on solubilities of Li₂CO₃ and LiOH in water. As shown in FIG. 9 in a graph 900 plotting each of Li₂CO₃ and LiOH content in a rinse solution relative to a water/NMC ratio, Li₂CO₃ may demand more equivalents of water for removal than LiOH and therefore may be used to determine the amount of water for sufficient rinsing. For example, effects of rinsing with different equivalences of water is shown in FIGS. 10 and 11 by graphs 1000 and 1100, respectively. Graph 1000 is plotted similarly to graph 300 of FIG. 3 and graph 1100 is plotted similarly to graph 400 of FIG. 4. Results of rinsing of one sample having a Li/TM mixing ratio of 1.08 with different amounts of water are illustrated, where the water/NMC ratios include 0:1 (pristine), 1:1, 2:1, 3:1, 4:1, and 5:1. Furthermore, a reference sample that is not infiltrated with Li is rinsed with 0.5:1 of water/NMC .

As shown in graph 1000 rinsing with increasing equivalents of water decreases overall surface Li until the ratio reaches 3:1 water/NMC. Increasing the amount of water beyond the 3:1 ratio does not show further reduction of the surface Li. The reference sample indicates an absence of any Li in the NMC or the water. A small decrease in structural Li is observed as the water/NMC ratio increases from 0:1 to 1:1 but remains relatively uniform at higher ratios, as depicted in graph 1100. The results plotted in graphs 1000 and 1100 indicates that rinsing with higher ratios than 3:1 water/NMC provides diminishing returns. Rinse ratios between 2:1 and 3:1 water/NMC may enable highest surface Li removal efficiency.

A process for rinsing may incorporate several steps, including rinsing, filtration, and drying. Parameters of each of the steps may be varied according to a specific sample and processing conditions. For example, the sample may be rinsed with a solution formed or one or more solvents in addition to water, such as ethanol, methanol, isopropanol, acetone, acetone nitrile, etc., depending on a solubility of a selected dopant salt. Further optimization of the rinsing process may include adjusting stirring speed, solution volume, rinsing time, rinsing temperature, drying time, etc.

Returning to FIG. 2, a fourth step 208 in the manufacturing process 200 may be a re-sintering step, or a second sintering to compact the rinsed NMC. The second sintering may affect the structural Li content depending on sintering parameters such as temperature, atmosphere, duration, and surface modification. Longer sintering in an atmosphere with carbon dioxide present may promote formation of Li₂CO₃, thereby decreasing the structural Li content. Sintering under a pure oxygen environment may control surface Li formation and conversion of surface Li back to structural Li may be possible. The conversion may demand a pure oxygen environment and may be dependent on an amount of surface Li present. When the surface Li is relatively low after rinsing, only a small amount may convert back to structural Li, such as ˜0.5 mol %.

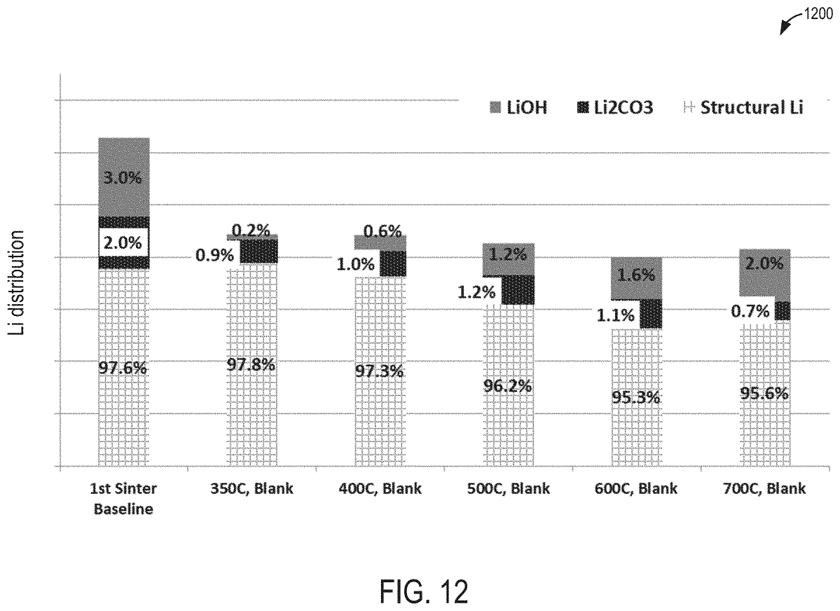

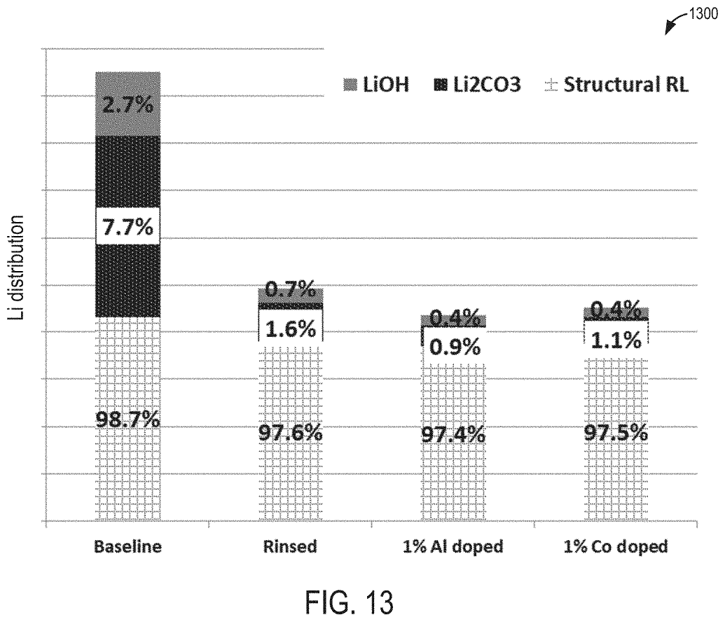

Temperature may also affect the total Li distribution. For example, an effect of temperature on total Li distribution during the second sintering is illustrated in FIG. 12 in graph 1200. A sample is divided into portions and each portion sintered at one of 350° C., 400° C., 500° C., 600° C., and 700° C., without any previous sintering. A baseline sample that has undergone sintering during the calcination step, e.g., the second step 204 of FIG. 2, is provided for comparison. The structural Li content is highest after sintering at 350° C. and decreases at higher temperatures. Furthermore, the LiOH content is lowest after sintering at 350° C.

As shown in FIG. 2, coating and surface doping of the NMC may also occur during the fourth step 208. For example, a process for the coating/surface doping may be performed as a single step by adding doping agent(s) before the second sintering. Surface doping of the NMC may include performing a dry doping treatment where the NMC and doping agent(s) may be mixed together (e.g., in a rotary evaporator) without a solvent. Alternatively, a wet doping treatment may be applied where the NMC and the doping agent(s) may be mixed together in a solvent, followed by drying and pulverization.

In another example, the NMC may undergo surface doping via a salt-rinse process, as described in U.S. patent application Ser. No. 17/443,805 and incorporated herein by reference. For example, at least one dopant salt may be dissolved in a solvent in which the salt has high solubility, such as water, an organic solvent, or a combination thereof, to form a dopant salt rinse solution. The NMC may be mixed with the dopant salt rinse solution, and the mixture may be transferred to a filtration system for filtration. A resulting filtrate, composed of the dopant salt and NMC, may be dried, e.g., in a vacuum oven, at 120° C. or less and the dried filtrate may be calcinated or sintered. Surface-doped NMC may thereby be obtained.

Surface doping may have a minimal effect on structural Li but may react with surface Li and decrease the surface Li content slightly. For example, as shown in FIG. 13 in graph 1300, total Li distribution for a sample is shown, where the sample is split into portions to which different doping treatments are applied. The percent Li/TM mixing ratio is shown along the y-axis and doping treatments are indicated along the x-axis. The doping treatments include a baseline treatment (e.g., no rinsing and no doping), a rinsed sample (e.g., no doping), doping with 1% Al, and doping with 1% Co. Surface Li is lower for both doped samples while structural Li is relatively uniform amongst the different treatments. Further, the surface dopants may be one or more of Al, Co, as shown in FIG. 13, as well as magnesium (Mg), and fluorine (F). Other elements for surface doping are also possible.

After the second sintering and coating/surface doping is conducted, fabrication of the NMC cathode may be complete. Examples of techniques and methods for determining total Li distribution to evaluate the steps of the manufacturing process 200 of FIG. 2 are described below.

### Examples of Analyses

### Example of Surface Lithium Evaluation

The surface Li was determined based on titration using a Metrohm 855 Robotic Titrosampler. For example, 5 g of a NMC precursor was mixed with 100 mL of deionized water and stirred on a stir plate for 30 minutes. The precursor solution was vacuum filtered after stirring through two layers of filter paper (pore size=7 μm). A portion (40 mL) of the filtered solution was diluted to 140 mL using deionized water and analyzed with the Titrosampler. Titration was completed using 20 mL of 0.1 M hydrochloric acid (HCl) as the titrant to determine concentrations of Li₂CO₃ and LiOH.

To calculate the amount of surface or residual Li in a sample, titration to respective equivalence points of Li₂CO₃ and LiOH was performed. The equivalence points were identified based on peaks of the derivative of the pH versus volume titration curve. The concentration of Li₂CO₃ was calculated based on Equation 2 below and the concentration of LiOH was calculated based on Equation 3 below, where VEP1 is the volume of titrant used to reach a first equivalence point and VEP2 is the volume of titrant used to reach a second equivalence point.

$$[ {Li}_{2} {CO}_{3} ] = \frac{\begin{matrix}( VEP 2 - VEP 1 ) * 0.1 \frac{mol}{L} * \\ 73.898 \frac{g}{mol} * 100 \% * 10000 \frac{ppm}{\%}\end{matrix}}{2 g * 1000 \frac{mL}{L}} \qquad ( 2 )$$

$$[ LiOH ] = \frac{\begin{matrix}( ( 2 * VEP 1 ) - VEP 2 ) * 0.1 \frac{mol}{L} * \\ 23.948 \frac{g}{mol} * 100 \% * 10000 \frac{ppm}{\%}\end{matrix}}{2 g * 1000 \frac{mL}{L}} \qquad ( 3 )$$

For some samples, VEP2 corresponded to a volume of titrant greater than 20 mL. In such instances, 20 mL of the filtered solution was diluted to 140 mL with deionized water and titrated against the titrant. For these samples, the mass (g) in the denominators of Equations 2 and 3 was 1 g instead of 2 g.

In general, VEP1 and VEP2 may fall within a range of 5 mL to 15 mL for results with greatest accuracy. In such instances, 80 L of the original filtered solution were taken and diluted to 140 mL with deionized water. For these samples, the weight in the denominators of Equations 2 and 3 was adjusted to 4 g from 2 g.

### Example of Total Lithium Composition Evaluation

A total Li/TM (where a total Li content includes surface and structural Li) of the samples was determined using Inductively Coupled Plasma-Atomic Emission Spectroscopy (ICP-AES) on a SPECTRO ARCOS instrument manufactured by AMETEK®. Four standard solutions were prepared and used for ICP-AES testing, as well as a fifth standard solution that was used as an internal standard. The standard solutions included Standard A, a blank standard with 50 mL of deionized water, Standard B, a solution of 10 ppm Li, 75 ppm Ni, 10 ppm Mn, and 10 ppm Co in 50 mL of deionized water, Standard C, a solution of 15 pp m Li, 100 ppm Ni, 20 ppm Mn, and 20 ppm Co in 50 mL of deionized water, and Standard D, a solution of 20 ppm Li, 125 ppm Ni, 30 ppm Mn, and 30 ppm Co in 50 mL of deionized water. The internal standard was a solution of 200 ppm scandium in 2 mL of nitric acid (HNO₃, 67-70% assay), and diluted to 100 mL with deionized water.

The samples were prepared for analysis by ICP-AES by dissolving 0.25 g of the sample in a 11 mL solution formed of 5 mL of deionized water, 4 mL of HCl (34-37% assay), 1 mL of HNO₃ (40-60% assay), and 1 mL of hydrofluoric acid (HF, 40-60% assay). The solution was allowed to digest for two hours at 95° C. after which the solution was diluted to 50 mL with deionized water to have a final HNO₃ concentration of 2%. An increment (2 mL) of the diluted solution was added to a separate vessel and mixed with 1 mL of HNO₃ (67-70% assay) and diluted again to 50 mL with deionized water. Resulting concentrations of Li and the TMs were within the concentration ranges of the standard solutions.

The prepared sample solutions were pumped through the ICP-AES instrument to generate electromagnetic radiation via formation of excited atoms and ions. Emission intensities across characteristic wavelengths of the samples were compared with those of the standard solutions to determine the concentrations of target elements (Li, Ni, Co, and Mn).

### Example of Electrochemical Evaluation

The electrochemical evaluation of the NMC powder samples was conducted in coin cells. A cathode electrode was formed of 93% NMC powder, 4 wt % carbon conductive additives, and 3 wt % polyvinylidene fluoride (PVDF) binder by mixing the constituents in a planetary mixer (THINKY), three times for 5 min at 2000 rpm. The mixture was cast on Al foil at an active mass loading of ˜7 mg/cm². The casted electrode was dried in a vacuum oven at 80° C. for two hours and calendered to a density of 3.2 g/cm² before being punched to a final target electrode size. The electrode was dried in a vacuum chamber at 120° C. overnight and assembled into CR 2025-type coin cells with a Li anode and Celgard® 2500 as a separator. A mixture of 1M lithium hexafluorophosphate (LiPF₆) dissolved in ethylene carbonate and diethyl carbonate (v:v=1:2) was used as an electrolyte.

### Results of Analyses of Experimental Procedures and Cathode Performance

Analysis and testing was conducted on samples formed of LiₐNiₓCo_{y}Mn_{1-x-y}O₂ where x=0.87. Other baseline cathode materials may be similarly used for analysis and testing, including LiₐNiₓCo_{y}Mn_{1-x-y}O₂ with various Li, Ni, Mn, Co content, Li-rich metals oxides such as xLi₂MnO₃·(1−x)LiMn_{y}Ni_{z}Co_{1-y-z}O₂, LiNiₓCo_{y}Al_{1-x-y}O₂, spinel lithium manganese oxide (LiMn2O4, LMO), spinel lithium nickel manganese oxide (LiNiₓMn₂₋ₓO₄), lithium iron phosphate (LiFePO₄), etc. Additionally, anodes may be used, such as lithium titanate oxide (Li₄Ti₅O₁₂).

Based on the analyses described above, target surface and structural Li contents (mol %) are illustrated in FIG. 14 in a map 1400. For example, the electrochemical analyses may be used to assess cathode performance corresponding to measured Li content as determined based on surface Li and total Li composition evaluation. The map 1400 includes thresholds of optimal Li content in a cathode for each of structural Li, surface Li₂CO₃, surface LiOH, and total surface Li.

For example, an optimal range of structural Li content, e.g., providing optimal cathode performance, may be defined by a first threshold 1402 and a second threshold 1404. The first threshold 1402 may be a lower boundary of the optimal range, such as 96 mol %, and the second threshold 1404 may be an upper boundary of the optimal range, such as 100 mol %. A third threshold 1406 may define an upper boundary of surface Li₂CO₃ content and a fourth threshold 1408 may define an upper boundary of surface LiOH content, which may each be 2.5 mol %. Degradation of cathode performance may occur when either of Li₂CO₃ or LiOH increases above the third and fourth thresholds 1406, 1408, respectively. Additionally, a fifth threshold 1410 may define an upper boundary of total surface Li content (e.g., a sum of surface Li₂CO₃ and surface LiOH), such as 4 mol %, above which decreased cathode performance may result. An exemplary summary of the results is provided below in Table 1.

TABLE 1
Optimal Li distribution in NMC cathodes.

| Li species | Optimal range | |
|---|---|---|
| Structural Li | 96-100 | mol % |
| Li₂CO₃ (surface) | <2.5 | mol % |
| LiOH (surface) | <2.5 | mol % |
| Surface Li (Li₂CO₃ + LiOH) | <4 | mol % |

The results shown in Table 1 and FIG. 14 were obtained based on analysis and testing of samples with different total Li content and different Li distribution. In one embodiment, a set of Li-NMC samples with high Ni content were prepared and tested to determine the optimal and threshold content ranges of surface and structural Li in a NMC cathode. The set of NMC samples included structural Li within, below, or above the subsequently determined optimal range shown in Table 1 and FIG. 14, and surface Li above or below the subsequently determined threshold mol % shown in Table 1 and FIG. 14. As the Li mol % is relative to Ni content in the transition metal (e.g., NMC) matrix, Samples 5 and 6 have mol % greater than 100%.

TABLE 2
Li-NMC samples for electrochemical testing

| Sample | Structural Lithium | Surface Lithium |
|---|---|---|
| 1 | 98.2 mol % (within) | 2.7 mol % (below) |
| 2 | 99.7 mol % (within) | 4.8 mol % (above) |
| 3 | 95.1 mol % (below) | 7.3 mol % (above) |
| 4 | 88.4 mol %(below) | 0.9 mol % (below) |
| 5 | 101.8 mol % (above) | 2.7 mol % (below) |
| 6 | 100.5 mol % (above) | 9.7 mol % (above) |

Each sample was analyzed for Li content/distribution and electrochemically tested via the methods described above. It will be noted that the values for structural Li are associated with an error margin of up to +/−2% while the values for surface Li are associated with an error margin of up to +/−1%, due to analysis of Li content by ICP-MS for total Li content (from which structural Li is determined) and by titration for surface Li. Values for Li distribution shown in Table 2 were obtained from results of Li content/distribution analysis shown in graph 1500 of FIG. 15. Graph 1500 is plotted similarly to graph 300 of FIG. 3 and shows the Li distribution for Samples 1-6 of Table 2 from left to right sequentially.

An initial charge capacity of each sample is shown in graph 1600 of FIG. 16 for both first charge capacity (FCC) and first discharge capacity (FDC). The capacity is given along the y-axis in mAh/g and the FCC and FDC for each of Samples 1-6 of Table 2 are shown from left to right sequentially. Samples 1 and 2, each having structural Li content within the optimal range, demonstrate highest FCC and FDC. The lowest initial capacities are exhibited by Samples 4 and 6. Samples with structural Li content below the optimal range may show decreased initial charge capacity due to a higher average oxidation state of the Ni in the NMC, which may suppress Li cation extraction during charging. Furthermore, a Li/Ni disorder ratio may be higher when structural Li content is low, which may contribute to a diffusion barrier of the NMC. For samples with structural Li content above the optimal range, the FCCs and FDCs are lower than the samples with optimal structural Li content and similar to the samples with low structural Li. However, the amount of surface Li may affect initial charge capacity. For example, Sample 5, with low surface Li, demonstrates a higher FCC and higher FDC than Sample 6, which has high surface Li. Similarly, Sample 1, with low surface Li, has both a higher FCC and FDC than Sample 2. Excess surface Li may act as inactive weight and block at least a portion of the diffusion paths along the NMC surfaces, which may lower charge capacity.

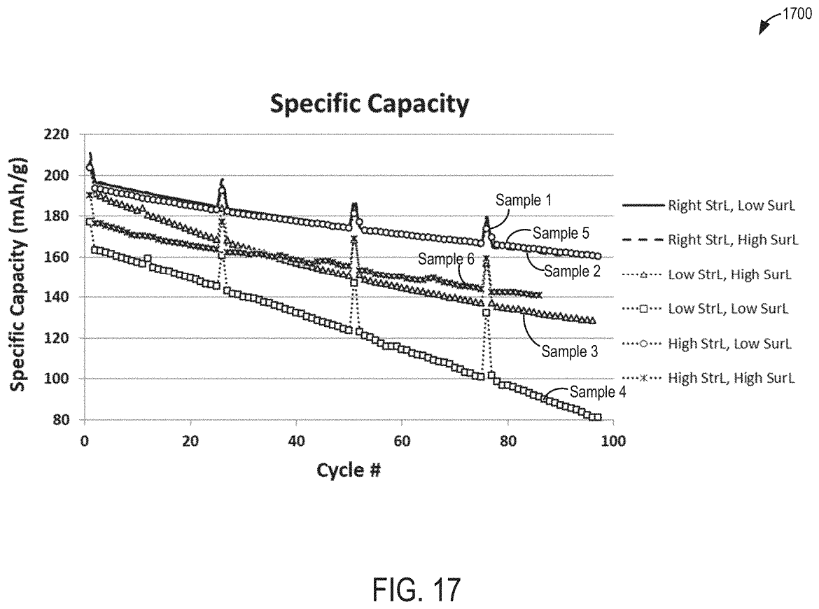

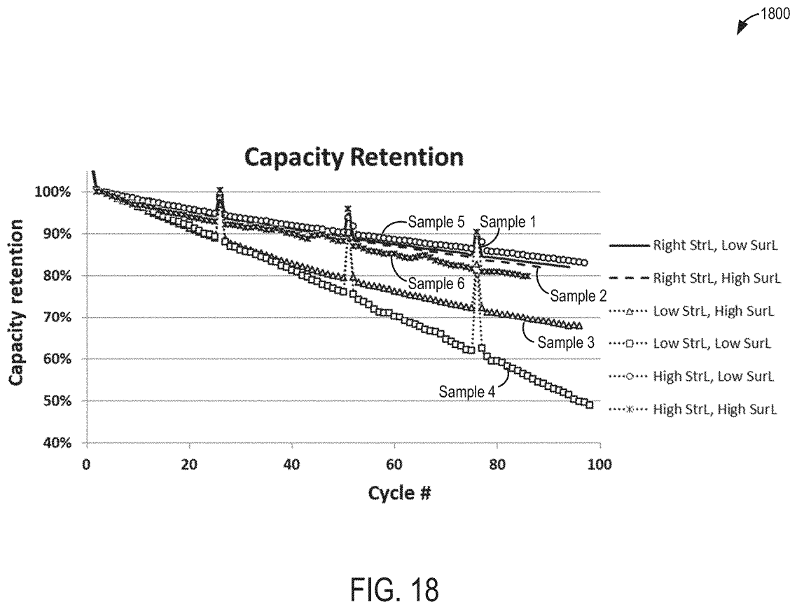

Specific capacity and retention capacity of the samples are compared in graphs 1700 and 1800 of FIGS. 17 and 18, respectively. The specific capacity is the charge capacity of the cathode per g (or weight) of cathode material, which is plotted in mAh/g along the y-axis of the graph 1700 relative to cycle number (e.g., where one cycle includes charging and discharging of a coin cell). Samples 1, 2, and 5 show the highest initial specific capacity and lowest degradation of specific capacity as cycle number increases. Sample 4 demonstrates the lowest initial specific capacity and greatest degradation of specific capacity as the cycle number increases. The results shown in graph 1700 indicate that regardless of surface Li content, structural Li content within the optimal range has a greater effect on achieving high cycling performance than samples with low structural Li content. Furthermore, samples with high structural Li content and with low surface Li content show similar results as samples with structural Li content within the optimal range. Surface Li may have little impact on the RT cycle life of coin cells using Li anodes as any loss of reversible Li⁺ resulting from side reactions between the surface Li and electrolyte may be compensated for by the Li anode. Large amounts of surface Li however, may react with the electrolyte and lead to poor cycle performance and gas generation in a full battery cell configuration, particularly at high temperature operation.

The retention capacity indicates an ability of a battery to retain stored energy during an extended open-circuit rest period. Percent capacity retained is depicted along the y-axis in graph 1800 of FIG. 18 relative to cycle number along the x-axis. Samples 1, 2, and 5 again demonstrate the least degradation of capacity retention as cycling progresses while Sample 4 exhibits the highest rate of degradation.

Behavior of the samples during the cycling tests plotted in graphs 1700 and 1800 may result from suppression of a Li-deficient phase which may be a phase within a layered structure of the NMC that lacks Li ions. The Li-deficient phase may form during battery charging. For example, Li ions may move through a battery electrolyte from an NMC cathode to an anode (e.g., an anode formed of graphite, silicon, or a combination thereof) as the battery is charging. The Li ions may be stored within a structure of the anode which may lead to formation of the Li-deficient phase in the NMC matrix. This may also suppress loss of Li resulting from formation of an irreversible phase of the Li. The irreversible phase may form during charging when Li ions extracted from the NMC are not re-inserted into the layered structure of the NMC. This may lead to a decreased retention capacity compared to a retention capacity from a previous cycle. Overall, samples with low structural Li content demonstrate poor cycling performance due to decreased charge transfer capability and samples with high surface Li may react with battery cell electrolyte, leading to gas generation and poor cycling, particularly at high operating temperatures.

The results of the cycling tests allow effects of Li distribution on electrode performance to be assessed according to the sample compositions shown in Table 2. For example, Sample 1 was found to have a desirable distribution, e.g., 99.7 mol % structural Li and 2.7 mol % surface Li. The Li/Ni mixing was low and the corresponding cathode gave high capacity and enhanced cycle life, resulting from a corresponding material selection and material processing.

For Sample 2, which included a large amount of surface Li, the excessive residual Li inhibited diffusion through the Li cation diffusion channels on the surfaces of the NMC particles. Thus, the residual Li may be inactive weight that lowers the capacity of the cathode. The presence of the residual Li may be a result of addition of an excess amount of Li salt during mixing with the NMC precursor. The cycle life, however is comparable to the cycle life of Sample 1 but with a lower initial capacity.

For Sample 3, the total Li is within a desirable range but the structural Li content is low which may be a result of non-ideal calcination conditions as the initial mixing ratio of Li salt to NMC precursor is correct. The calcination conditions may have led to an insufficient diffusion/reaction of the Li salt into the NMC precursor or presence of CO₂. Additionally or alternatively, moisture in the calcination atmosphere may have driven more favorable growth of surface Li over structural Li.

For Sample 4, the structural Li and the surface Li were both low, therefore lowering the total Li. The low Li content may be a result of low initial Li/TM mixing ratio, incorrect calcination conditions, and/or aggressive rinsing. As a result, low capacity and poor cycle life were demonstrated.

For Samples 5 and 6, structural Li content was high in each sample but the surface Li content differed. For these examples, the structural Li is over 100 mol % and the Li/Ni mixing is low. The capacities of the samples are only slightly lower than for Sample 1 and remain within a desirable range due to the low Li/Ni mixing and decreased surface defects. However, for the Sample 6, the high surface Li content lowers the capacity relative to Sample 5. In this way, an electrochemical performance, such as charge capacity, energy density, and cycling capacity, of a cathode for a Li-ion battery cell may be increased based on a distribution of Li between a surface of the cathode and within interstitial sites of the cathode base material matrix (e.g., crystal structure). A proportion of Li at the surface of the cathode may be decreased while maintaining a high ratio of Li to transition metals, the transition metals forming the base material of the cathode, by optimizing manufacturing steps of the cathode, such as rinsing, calcination, and sintering, to achieve target Li distributions. As a result, the cathode may exhibit higher energy storage and lower degradation of charge capacity during cycling, in comparison to conventionally prepared cathodes fabricated without controlled Li distribution.

In this way, an electrode with an electrochemical performance, e.g., charge capacity and energy storage, that remains robust over prolonged cycling, while exhibiting low gas generation, may be formed via low cost processing techniques. The performance of the electrode may be dependent on a distribution or partitioning of Li between interstitial sites (e.g., structural or bulk Li) and surfaces of the electrode (e.g., surface Li). Enhanced electrode performance may be enabled by increasing an amount of structural Li while decreasing an amount of surface Li, which may be achieved based on processing of materials during a fabrication process, as described herein. The structural Li content of a resulting electrode may be used as an indicator of a performance of the electrode. By optimizing processes performed during fabrication of the electrode, a target structural Li content of the electrode may be obtained while minimizing a presence of residual, surface Li.

The disclosure also provides support for a method for fabricating an electrode, comprising: increasing an electrochemical performance of a battery by adjusting a distribution of lithium in the electrode between a surface and interstitial sites of the electrode during a fabrication process, the fabrication process including mixing, calcinating, rinsing, and sintering electrode materials, and wherein the fabrication process is optimized to increase lithium in the interstitial sites and decrease lithium at the surface of the electrode. In a first example of the method, adjusting the distribution of lithium in the electrode includes controlling the distribution of lithium between the surface and the interstitial sites of a nickel manganese cobalt oxide (NMC) matrix of the electrode and wherein the electrode has a composition of LiNixMnyCo1-x-yO2. In a second example of the method, optionally including the first example, a ratio of lithium to transition metals to oxide of the NMC is 1:1:1, the transition metals including nickel, manganese, and cobalt, and wherein a composition of the transition metals is nickel-rich. In a third example of the method, optionally including one or both of the first and second examples, mixing the electrode materials includes mixing a NMC precursor, a lithium salt, and a bulk dopant, and selecting quantities of the lithium salt and the NMC precursor to obtain an electrode lithium to transition metal ratio of greater than 1. In a fourth example of the method, optionally including one or more or each of the first through third examples, the electrode lithium to transition metal ratio of greater than 1 is obtained by mixing the lithium salt and the NMC precursor at a lithium to transition metal ratio of at least 1.07:1. In a fifth example of the method, optionally including one or more or each of the first through fourth examples, calcinating the electrode materials includes heating the electrode materials according to a calcination temperature profile and wherein the calcination temperature profile includes a pre-sintering phase and a calcination phase. In a sixth example of the method, optionally including one or more or each of the first through fifth examples, the pre-sintering phase is conducted at a lower temperature then the calcination phase, and wherein a temperature of the pre-sintering phase is a temperature that enables melting and percolating of a lithium salt into a NMC precursor. In a seventh example of the method, optionally including one or more or each of the first through sixth examples, calcinating the electrode materials includes heating the electrode materials under a pure oxygen atmosphere. In a eighth example of the method, optionally including one or more or each of the first through seventh examples, rinsing the electrode materials includes rinsing the electrode materials with water after calcinating to decrease lithium disposed on the surface of the electrode. In a ninth example of the method, optionally including one or more or each of the first through eighth examples, sintering the electrode materials includes doping a surface of the electrode with a dopant and heating the electrode materials under a pure oxygen atmosphere to increase a ratio of lithium in the interstitial sites to lithium at the surface of the electrode. In a tenth example of the method, optionally including one or more or each of the first through ninth examples, increasing the electrochemical performance of the battery includes increasing one or more of an initial charge capacity, a specific capacity and a retention capacity of the electrode.

The disclosure also provides support for a battery electrode, comprising: a transition metal matrix, and lithium distributed across surfaces of the battery electrode and intercalated into the transition metal matrix, wherein a lithium distribution of higher lithium content in the transition metal matrix than at the surfaces is obtained by optimizing processing steps of the battery electrode during fabrication, the processing steps including mixing, calcinating, rinsing, and sintering. In a first example of the system, the transition metal matrix is a crystal structure lattice of nickel manganese cobalt oxide (NMC). In a second example of the system, optionally including the first example, an amount of the lithium content in the transition metal matrix is between 96 mol %-100 mol % of a total lithium content of the battery electrode. In a third example of the system, optionally including one or both of the first and second examples, an amount of a lithium content at the surfaces of the battery electrode is less than 2.5 mol % of a total lithium content of the battery electrode, and wherein the lithium content at the surfaces of the battery electrode includes lithium carbonate (Li2CO3) and lithium hydroxide (LiOH), and an amount of each of Li2CO3 and LiOH is less than 2.5 mol % of the total lithium content of the battery electrode.

The disclosure also provides support for a method for a lithium-ion battery, comprising: mixing precursors of a cathode to achieve a target lithium to transition metal ratio, calcinating the precursors according to a calcination temperature profile to increase a structural lithium content relative to surface lithium content of a calcinated product formed from the precursors, rinsing the calcinated product to remove surface lithium, and sintering the calcinated product after rinsing to form the cathode with low surface lithium and high structural lithium. In a first example of the method, mixing the precursors includes mixing a bulk dopant with a lithium salt and a nickel manganese cobalt oxide (NMC) precursor, and wherein the bulk dopant includes one or more of Al, Mg, Mn, Co, Ni, Ti, Zr, Sn, Cu, Ca, Ba, Ce, Y, Nd, W, Ba, Na, K, F, Cl, Br, I, S, Se, P, Sb, Bi, Si, Ge, Sn, Ph, Ga, In, and Ag oxide or salt. In a second example of the method, optionally including the first example, the precursors are heated according to the calcination temperature profile under a pure oxygen atmosphere to decrease a ratio of surface lithium to structural lithium, and wherein structural lithium is lithium incorporated into a crystal structure of a NMC matrix formed from the NMC precursor. In a third example of the method, optionally including one or both of the first and second examples, rinsing the calcinated product includes rinsing the calcinated product with a water to NMC ratio of at least 3:1. In a fourth example of the method, optionally including one or more or each of the first through third examples, calcinating the precursors according to the calcination temperature profile includes heating the precursors during a pre-sintering phase of the calcination temperature profile at a temperature of 350° C.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for fabricating an electrode, comprising:
increasing an electrochemical performance of a battery by adjusting a distribution of lithium in the electrode between a surface and interstitial sites of the electrode during a fabrication process, the fabrication process including mixing, calcinating, rinsing, and sintering electrode materials, and wherein the fabrication process is optimized to increase lithium in the interstitial sites and decrease lithium at the surface of the electrode.

2. The method of claim 1, wherein adjusting the distribution of lithium in the electrode includes controlling the distribution of lithium between the surface and the interstitial sites of a nickel manganese cobalt oxide (NMC) matrix of the electrode and wherein the electrode has a composition of LiNiₓMn_{y}Co_{1-x-y}O₂.

3. The method of claim 2, wherein a ratio of lithium to transition metals to oxide of the NMC is 1:1:1, the transition metals including nickel, manganese, and cobalt, and wherein a composition of the transition metals is nickel-rich.

4. The method of claim 3, wherein mixing the electrode materials includes mixing a NMC precursor, a lithium salt, and a bulk dopant, and selecting quantities of the lithium salt and the NMC precursor to obtain an electrode lithium to transition metal ratio of greater than 1.

5. The method of claim 4, wherein the electrode lithium to transition metal ratio of greater than 1 is obtained by mixing the lithium salt and the NMC precursor at a lithium to transition metal ratio of at least 1.07:1.

6. The method of claim 1, wherein calcinating the electrode materials includes heating the electrode materials according to a calcination temperature profile and wherein the calcination temperature profile includes a pre-sintering phase and a calcination phase.

7. The method of claim 6, wherein the pre-sintering phase is conducted at a lower temperature then the calcination phase, and wherein a temperature of the pre-sintering phase is a temperature that enables melting and percolating of a lithium salt into a NMC precursor.

8. The method of claim 1, wherein calcinating the electrode materials includes heating the electrode materials under a pure oxygen atmosphere.

9. The method of claim 1, wherein rinsing the electrode materials includes rinsing the electrode materials with water after calcinating to decrease lithium disposed on the surface of the electrode.

10. The method of claim 1, wherein sintering the electrode materials includes doping a surface of the electrode with a dopant and heating the electrode materials under a pure oxygen atmosphere to increase a ratio of lithium in the interstitial sites to lithium at the surface of the electrode.

11. The method of claim 1, wherein increasing the electrochemical performance of the battery includes increasing one or more of an initial charge capacity, a specific capacity and a retention capacity of the electrode.

12. A battery electrode, comprising:
a transition metal matrix; and
lithium distributed across surfaces of the battery electrode and intercalated into the transition metal matrix, wherein a lithium distribution of higher lithium content in the transition metal matrix than at the surfaces is obtained by optimizing processing steps of the battery electrode during fabrication, the processing steps including mixing, calcinating, rinsing, and sintering.

13. The battery electrode of claim 12, wherein the transition metal matrix is a crystal structure lattice of nickel manganese cobalt oxide (NMC).

14. The battery electrode of claim 12, wherein an amount of the lithium content in the transition metal matrix is between 96 mol %-100 mol % of a total lithium content of the battery electrode.

15. The battery electrode of claim 12, wherein an amount of a lithium content at the surfaces of the battery electrode is less than 2.5 mol % of a total lithium content of the battery electrode, and wherein the lithium content at the surfaces of the battery electrode includes lithium carbonate (Li₂CO₃) and lithium hydroxide (LiOH), and an amount of each of Li₂CO₃ and LiOH is less than 2.5 mol % of the total lithium content of the battery electrode.

16. A method for a lithium-ion battery, comprising:
mixing precursors of a cathode to achieve a target lithium to transition metal ratio;
calcinating the precursors according to a calcination temperature profile to increase a structural lithium content relative to surface lithium content of a calcinated product formed from the precursors;
rinsing the calcinated product to remove surface lithium; and
sintering the calcinated product after rinsing to form the cathode with low surface lithium and high structural lithium.

17. The method of claim 16, wherein mixing the precursors includes mixing a bulk dopant with a lithium salt and a nickel manganese cobalt oxide (NMC) precursor, and wherein the bulk dopant includes one or more of Al, Mg, Mn, Co, Ni, Ti, Zr, Sn, Cu, Ca, Ba, Ce, Y, Nd, W, Ba, Na, K, F, Cl, Br, I, S, Se, P, Sb, Bi, Si, Ge, Sn, Pb, Ga, In, and Ag oxide or salt.

18. The method of claim 17, wherein the precursors are heated according to the calcination temperature profile under a pure oxygen atmosphere to decrease a ratio of surface lithium to structural lithium, and wherein structural lithium is lithium incorporated into a crystal structure of a NMC matrix formed from the NMC precursor.

19. The method of claim 16, wherein rinsing the calcinated product includes rinsing the calcinated product with a water to NMC ratio of at least 3:1.

20. The method of claim 16, wherein calcinating the precursors according to the calcination temperature profile includes heating the precursors during a pre-sintering phase of the calcination temperature profile at a temperature of 350° C.
